(19) United States
(12) Patent Application Publication
(10) Pub. No.: US 2015/0170414 A1
(43) Pub. Date: Jun. 18, 2015

(54) Automated Model Browsing

(71) Applicants: Dale HAWKINS, Erie, CO (US); Brian Brewington, Fort Collins, CO (US); James A. Guggemos, Windsor, CO (US); Allison Floyd, Fort Collins, CO (US)

(72) Inventors: Dale HAWKINS, Erie, CO (US); Brian Brewington, Fort Collins, CO (US); James A. Guggemos, Windsor, CO (US); Allison Floyd, Fort Collins, CO (US)

(73) Assignee: Google Inc., Mountain View, CA (US)

(21) Appl. No.: 13/198,452

(22) Filed: Aug. 4, 2011

(51) Int. Cl. G06T 17/10

(52) U.S. Cl. CPC G06T 17/10

(57) ABSTRACT

A system, computer-implemented method, and computer-readable medium for browsing geometric models are provided. A two-dimensional (2D) representation of a three dimensional (3D) geometric model and first and second criteria for the 3D geometric model selected by a user are provided to a geometric model warehouse. The geometric model warehouse determines a first set of 3D geometric models related to the 3D geometric model, based on the first criteria. The geometric model warehouse also determines a second set of 3D geometric models related to the 3D geometric model based on the second criteria. The geometric model warehouse sends the determined first and second sets of 3D geometric models for display to a client device.

### BACKGROUND

1. Field

The field generally relates to displaying geometric models.

2. Background Art

The emergence and development of computer networks and protocols, such as the Internet and the World Wide Web (or simply “web” or “Web”), allows users to use their computing devices to connect to servers and download, upload, share and display resources using their own computers. For example, users can upload images that include three dimensional (3D) geometric models of cities, towns, historic landmarks, buildings, bridges, transportation vehicles, etc., around the world. Such geometric models allow users to view historic landmarks and building around the world from their computer.

Conventional systems allow a user to download geometric models from a web server and display images of those models on a client device. Typically, those images are organized according to query types, such as “UNESCO sites”, “museums” and “sport venues,” to name a few. However, conventional systems do not allow a user to select geometric models based on multiple criteria that may enhance a number of geometric models available to the user.

### BRIEF SUMMARY

A system, computer-implemented method, and computer-readable medium for browsing geometric models are provided. A two-dimensional (2D) representation of a three dimensional (3D) geometric model and first and second criteria for the 3D geometric model selected by a user are provided to a geometric model warehouse. The geometric model warehouse determines a first set of 3D geometric models related to the 3D geometric model, based on the first criteria. The geometric model warehouse also determines a second set of 3D geometric models related to the 3D geometric model based on the second criteria. The geometric model warehouse sends the determined first and second sets of 3D geometric models for display to a client device.

Further embodiments, features, and advantages of the invention, as well as the structure and operation of the various embodiments of the invention are described in detail below with reference to accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a block diagram of a system suitable for storing and displaying geometric models.

FIG. 2A is a block diagram of an exemplary geometric model display provided to a user.

FIG. 2B is a block diagram of an exemplary geometric model display that includes actual images.

FIG. 3 is a flowchart of a method for selecting criteria and displaying the geometric model sets.

FIG. 4 is a flowchart of a method for geometric model warehouse determining geometric model sets for a focal model.

FIG. 5 is a flowchart of a method for a user selecting and displaying a new geometric model.

FIG. 6 is an exemplary computer system in which embodiments of the invention can be implemented.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

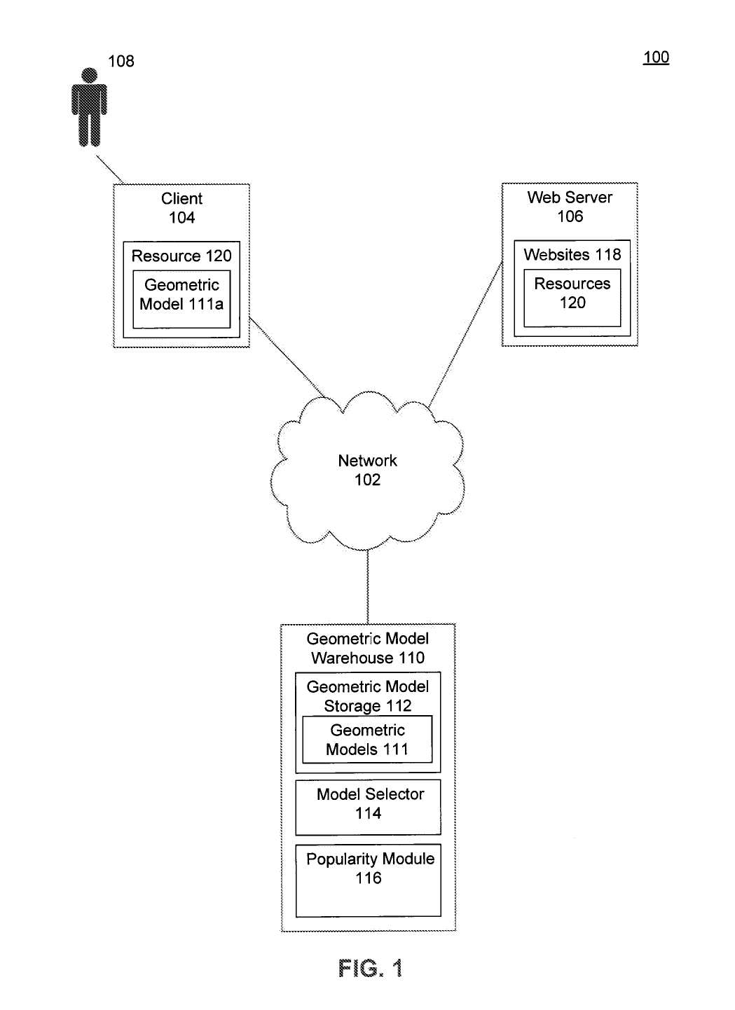

FIG. 1 is a block diagram of a distributed system environment 100 capable of generating geometric model sets from criteria selected by a user. Distributed system environment 100 includes one or more networks 102, clients 104, web servers 106, and geometric model warehouses 110.

Network 102 may be any network or combination of networks that can carry data communication. Such a network 102 may include, but is not limited to, a local area network, metropolitan area network, and/or wide area network such as the Internet. Network 102 can support protocols and technology including, but not limited to, World Wide Web protocols and/or services. Intermediate web servers, gateways, or other servers may be provided between components of the system shown in FIG. 1, depending upon a particular application or environment.

Web server 106 is a computing device or an application executing on a computing device that helps deliver resources 120, such as websites 118 to clients 104. Website 118 may include one or more resources 120 associated with a domain name and hosted by one or more web servers 106. An example website is a collection of web pages formatted in hypertext markup language (HTML) that can contain text, images, multimedia content, and programming elements, such as scripts.

A resource 120 is any data that can be provided over network 102. Resource 120 is identified by a resource address that is associated with resource 120. Resources 120 include HTML pages, word processing documents, and portable document format (PDF) documents, images, video, and feed sources, to name only a few. Resources 120 can include content, such as words, phrases, images and sounds, that may include embedded information (such as meta-information in hyperlinks) and/or embedded instructions (such as JavaScript scripts). Resources 120 may also include images of geometric models 111 stored in geometric model warehouse 110, as described herein.

Client 104 is an electronic device that is under the control of a user 108 and is capable of requesting and receiving resources 120 over network 102. Example clients 104 include personal computers, mobile communication devices, (e.g., smartphones, tablet computing devices, notebooks), set-top boxes, game-console embedded systems, and other devices that can send and receive data over the network 102. Client 104 typically includes a user application, such as a web browser that facilitates the sending and receiving of data and resources 120 over network 102.

Geometric models 111 are images or other two dimensional representations of various real-world objects. In an embodiment, geometric models 111 may be associated with a geographic location in the real world. Example, geometric models 111 may be 3D representations of buildings, bridges, monuments, signs, landmarks, etc., to name only a few.

Such geometric models 111 may be created by a third-party data provider or user 108. User 108 can generate geometric models 111 using 3D modeling software applications. In another example, user 108 can download geometric model 111 from web server 106 and use the 3D modeling software application to modify or create a new image of geometric model 111.

In addition to an image, geometric model 111 includes various attributes. Those attributes may include, but are not limited to, an author of the model, geographic region of the model, popularity score of the model, architectural style, structural similarity to other geometric models 111, etc.

Geometric models 111 are stored in geometric storage warehouse 110. Geometric model warehouse 110 can reside on web server 106 or another computing device that communicates with web server 106 using network 102.

Geometric model warehouse 110 includes a geometric model storage 112, a model selector 114 and a popularity module 116. Geometric model storage 112 stores geometric models 111 and their attributes. When user 108 requests geometric models 111 using a browser on client 104, client 104 submits a request to geometric model warehouse 110. In response, geometric model warehouse 110 retrieves geometric models 111 from geometric model storage 112 and sends a response message to client 104 that includes geometric models 111.

In conventional systems, users submit requests to geometric model warehouses that include selection criteria and geometric model warehouses return geometric models in response to those selection criteria. For example, if a user requests a geometric model of a “bridge”, geometric model warehouse returns a response message that includes geometric models of different types of bridges stored. The user does not have an ability to request other geometric models that are within the vicinity of the bridge or landmarks that have a similar shape to the bridge, but may or may not be an actual bridge, or bridges that are similar in shape to the selected bridge.

Unlike conventional systems, when users 108 request geometric models 111 based on a particular geometric model 111 and multiple selection criteria, user 108 can receive geometric models 111 that are related to each other based on the selected criteria and the particular geometric model 111. Example selection criteria for geometric models 111 may include an author, geographic location, nearby models, similar shapes, similar architecture and similar popularity, to name only a few.

User 108 communicates with geometric model warehouse 110 through websites 118 hosted on web server 106. When user 108 connects to website 118, user selects a focal model 111a and the criteria for focal model 111a. The browser then sends a message that includes focal model 111a and the selected criteria to geometric model database 110. Focal model 111a is geometric model 111 for which user 108 selects criteria.

Model selector 114 generates geometric model sets based on focal model 111a and the selected criteria received from user 108. Each criterion corresponds to one or more attributes that are associated with focal model 111a. Model selector 114 scans through the attributes of geometric models 111 stored in geometric model storage 112 and determines geometric models sets that are related to focal model 111a according to the selected criteria. For example, user 108 may request geometric model sets for focal model 111a based on selected criteria, such as “nearby models” and “similar shapes.” Model selector 114 then determines a geometric model set that includes geometric models 111 that are near to focal model 111a and another geometric model set that includes geometric models 111 that have a similar shape to focal model 111a.

Model selector 114 may also determine geometric model sets from each geometric model 111 identified in geometric model sets based on “nearby models” or “similar shapes” or both.

For example, when user 108 selects criteria such as “nearby models” and “similar shapes” for a geometric model of a pyramid at the Louver Museum in Paris, France, user 108 may receive several geometric model sets. Model selector 114 may generate a geometric model set that includes geometric models 111 that are near to the pyramid at the Louver Museum, such as, for example, an Eiffel Tower. Model selector 114 may generate another geometric model set that includes geometric models 111 that are similar in shape to the pyramid at the Louver Museum, such as, for example, a pyramid at Giza in Cairo, Egypt.

Model selector 114 may also generate additional geometric model sets that are based on geometric models 111 included in the generated geometric model sets and the selected criteria. For example, model selector 114 may generate a geometric model set that includes a geometric model of the Sphinx in Cairo, Egypt, by selecting the “nearby model” criterion and the geometric model of the pyramid at Giza. In another example, model selector 114 may generate a geometric model set that includes a geometric model of the Empire State Building in New York, USA, by selecting the “similar shapes” criterion and the geometric model of the Eiffel Tower.

Popularity module 116 determines popularity of each geometric model 111. Popularity module 116 may determine the popularity of each geometric model 111 based on the input of user 108. For example, popularity module 116 tracks a number of views, downloads, clicks that users 108 make for a particular geometric model 111. Popularity module 116 may retrieve the above data by scanning the log files produced by geometric module warehouse 110 when users 108 request geometric models 111. Popularity module 116 then compiles the scanned data off-line and generates a popularity score. The popularity score may be stored in the popularity attribute associated with each geometric model 111. A person skilled in the art will appreciate that geometric models 111 that have a high popularity score are geometric models 111 that are often queried and are typically geometric models 111 that are interesting to the user.

When model selector 114 generates geometric model sets, model selector 114 accesses the popularity attribute and ranks geometric models 111 in each geometric model set according to the value of the popularity attribute. In one embodiment, geometric models 111 in each geometric model set are sent to user 108 if they have a popularity score above a predefined threshold.

In another embodiment, when model selector 114 generates additional geometric model sets based on geometric models 111 in the generated geometric model sets and the selected criteria, model selector 114 also generates the additional geometric model sets based on the popularity score. For example, model selector 114 may retrieve the popularity score from the popularity attribute associated with each geometric model 111 in the generated geometric model set, rank geometric models 111 according to their popularity scores and recursively apply the selection criteria to geometric models 111 in the order based on the ranked popularity score. This allows model selector 114 to generate additional geometric model sets that are relevant to each other and include geometric models 111 that are interesting to the user.

After model selector 114 completes generating geometric model sets, web server 106 sends the generated geometric model sets to client 104.

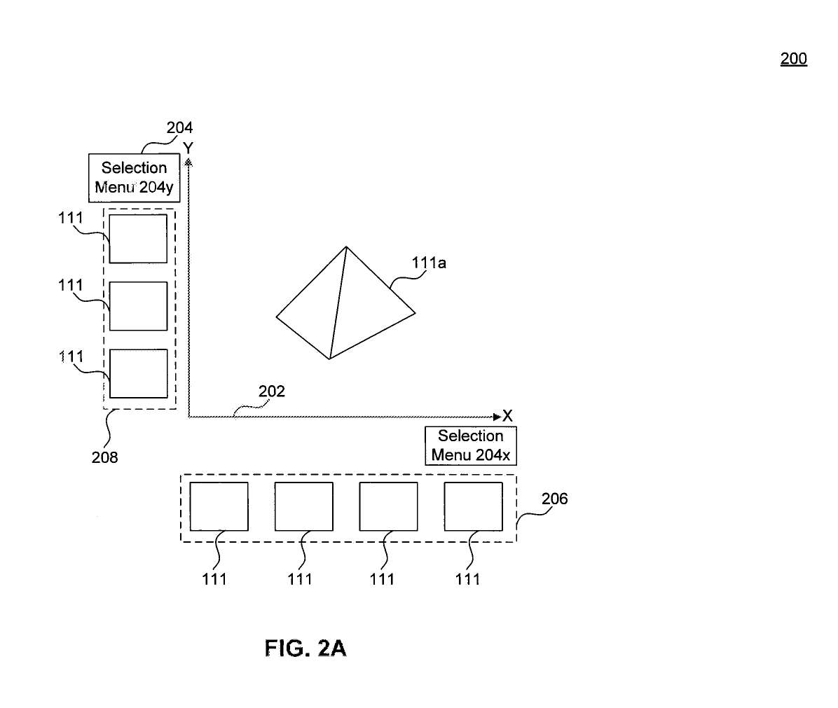

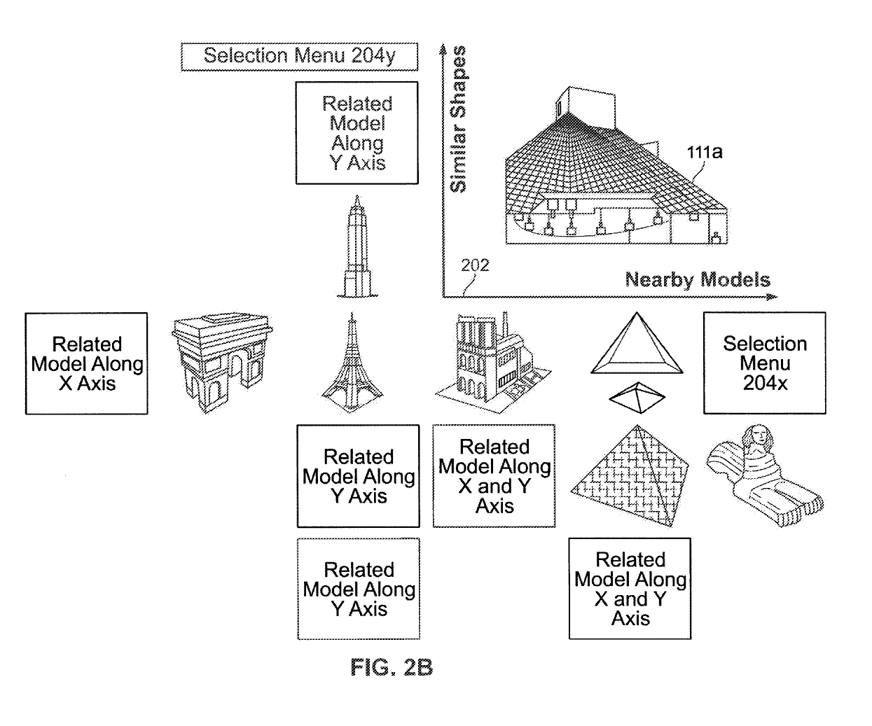

Client 104 displays geometric model sets to user 108. For example, client 104 uses browser to display geometric model sets as an interactive webpage. FIG. 2A is a block diagram of an exemplary embodiment 200 of geometric model sets being displayed to user 108.

Block diagram 200 may be a webpage that displays geometric models 111 around the x-y axis 202. Focal model 111a may be included in the positive quadrant of the x-y axis. Geometric model sets may be displayed as geometric model set 206 and geometric models set 208. Geometric model set 206 may correspond to geometric models 111 that geometric model warehouse 110 selected based on the first criteria selected by user 108. Geometric model set 206 may be displayed along the x-axis, as shown in FIG. 2A. Geometric model set 208 may correspond to geometric models 111 that geometric model warehouse 110 selected based on the second criteria selected by user 108. Geometric model set 208 may be displayed along the y-axis, as shown in FIG. 2A.

Selection menu 204 is a selection menu of the criteria that user 108 may choose to retrieve geometric model sets. Selection criteria may correspond to the attributes of geometric models 111 stored in geometric model warehouse 110. Selection menu 204 may be selection menu 204x that corresponds to selection criteria used to retrieve geometric model set 206, or selection menu 204y that corresponds to selection criteria used to retrieve geometric model set 208.

Geometric models 111 in geometric model sets 206 and 208 may be displayed according to their popularity. For example, geometric models 111 that have a more popular score may be displayed before geometric models 111 that have a less popular score.

User 108 may navigate and browse through geometric model sets 206 and 208. In one example, user 108 may use a mouse, a keyboard or a touch display to scroll through geometric model sets 206 and 208. As user 108 scrolls through geometric models 111, client 104 displays new geometric models 111 as old geometric models 111 disappear from view. Geometric model sets 206 and 208 may link the first and last geometric model in the respective geometric model sets, such that when user 108 scrolls to the last geometric model 111 in the geometric model set, it is followed by the first geometric model 111 in the same geometric model set. This feature, allows user 108 to scroll infinitely through geometric model sets 206 and 208 and have geometric models 111 repeat when user 108 scrolls through the entire geometric model set.

A webpage may also display geometric model sets that are related to geometric model 111 in a different set (not shown in FIG. 2A). Those geometric model sets may be below or to the one side to the related geometric model 111. Moreover, those geometric model sets may be related to geometric model 111 according to first or second selection criteria, or both.

User 108 may select a different focal model 111a from geometric model sets 206 and 208. To select a new focal model 111a, user 108 may select geometric model 111 from geometric model set 206 or 208 and drag the selected geometric model 111 to the location of the positive quadrant of the x-y axis. In one embodiment, when browser determines that a new focal model 111a is selected, the browser may cause client 104 to send a message to web server 106 with a request to generate new geometric model sets 206 and 208. In another embodiment, client 104 may send a request to geometric model warehouse 110 after user 108 presses a search button (not shown) or has modified the selection criteria in selection menus 204x or 204y.

FIG. 2B is a block diagram 200B of geometric model sets being displayed to user 108 with the geometric model of a pyramid at Louver Museum being focal model 111a. Block diagram 200B is described herein with references to terminology in FIG. 2A.

In block diagram 200B, user 108 selects criteria “nearby models” from the selection criteria 204x and “similar shapes” from the selection criteria 204y. The criteria “nearby models” and “similar shapes” are sent to geometric model warehouse 110 along with focal model of the pyramid at Louver Museum.

In response, geometric model warehouse 110 selects a set of geometric models 206 that describe “nearby models” and are displayed along the x-axis. Example nearby geometric models include the Eiffel Tower, the Notre Dome, and the Arc De Triomphe, also located in Paris, France.

Geometric model warehouse 110 also selects geometric model set 208 that describes “similar shapes” and is displayed along the y-axis. Example geometric model set includes a pyramid at Giza as demonstrated in FIG. 2B.

Geometric model warehouse 110 also selects a geometric model set that has “similar shapes” to geometric model 111 identified in geometric model set 208. For example, geometric model warehouse 110 determines a geometric model set that includes geometric models 111 having shapes similar to geometric model of the Eiffel Tower. Included in this geometric model set is a geometric model of an Empire State Building in New York, USA.

In another example, geometric model warehouse 110 selects a geometric model set that includes “nearby models” to geometric model 111 identified in geometric model set 206. For example, geometric model warehouse 110 determines geometric model set that includes geometric models 111 that are nearby to the Pyramid at Giza. In an embodiment, geometric model warehouse 110 identifies the geometric model set recursively and based on popularity score of geometric models 111 in geometric model set 206. Included in this determined geometric model set is a geometric model of the Sphinx.

In another example, geometric model warehouse 110 selects a geometric model set that includes “similar shapes” to geometric model 111 identified in geometric model set 208. For example, geometric model warehouse 110 determines a geometric model set that includes geometric models 111 that are similar to the Eiffel Tower. In an embodiment, geometric model warehouse 110 identifies the geometric model set recursively and based on popularity score of geometric models 111 in geometric model set 208. Included in this geometric model set is a geometric model of the Empire State Building.

Geometric model warehouse 110 may generate a geometric model set that is related to geometric model 111 included in the generated geometric model set 206 and 208 according to both “nearby models” and “similar shapes” criteria as described by a placeholder square in FIG. 2B captioned “Related Model Along X and Y Axis.”

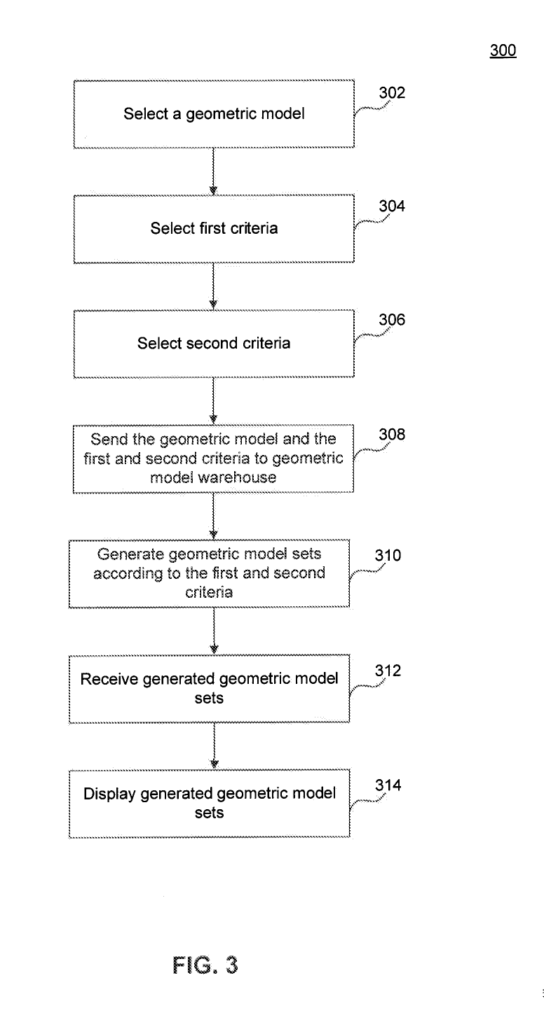

FIG. 3 is a flowchart of a method 300 for selecting criteria and displaying geometric model sets, according to an embodiment.

At stage 302, a focal model 111a is selected. For example, client 104 may receive an indication from user 108 using a browser to request focal model 111a with an image of a specific structure or a monument.

At stage 304, a first criterion is selected. For example, client 104 may receive an indication that user 108 selected a first criteria from the selection menu 204x.

At stage 306, a second criterion is selected. For example, client 104 may receive an indication that user 108 selected a second criteria from the selection menu 204y.

At stage 308, a browser on client 104 sends focal model 111a, the first criteria and the second criteria to geometric model warehouse 110.

At stage 310, geometric model warehouse 110 generates geometric model sets. For example, geometric model warehouse 110 generates geometric model sets 206 and 208 according to the first and second criteria. Geometric model warehouse 110 may also generate additional geometric model sets that are related to each geometric model 111 in geometric model sets 206 and 208 using the selected criteria. In an embodiment, geometric model sets 206 and 208 and the additional geometric model sets are generated recursively based on the popularity score.

At stage 312, client 104 receives geometric model sets. For example, client 104 receives geometric model sets 206 and 208 generated in stage 310 from geometric model warehouse 110 via web server 106. Client 104 may also receive geometric model sets generated from geometric models 111 included in geometric model sets 206 and 208.

At stage 314, client 104 displays geometric model sets 206 and 208 and focal model 111a. For example, geometric model sets received at stage 312 may be displayed as geometric model sets 206 and 208 in FIG. 2A. When geometric model warehouse 110 generates geometric model sets that are related to geometric models 111 in the generated geometric model sets, client 104 may display geometric model sets as described in FIG. 2B.

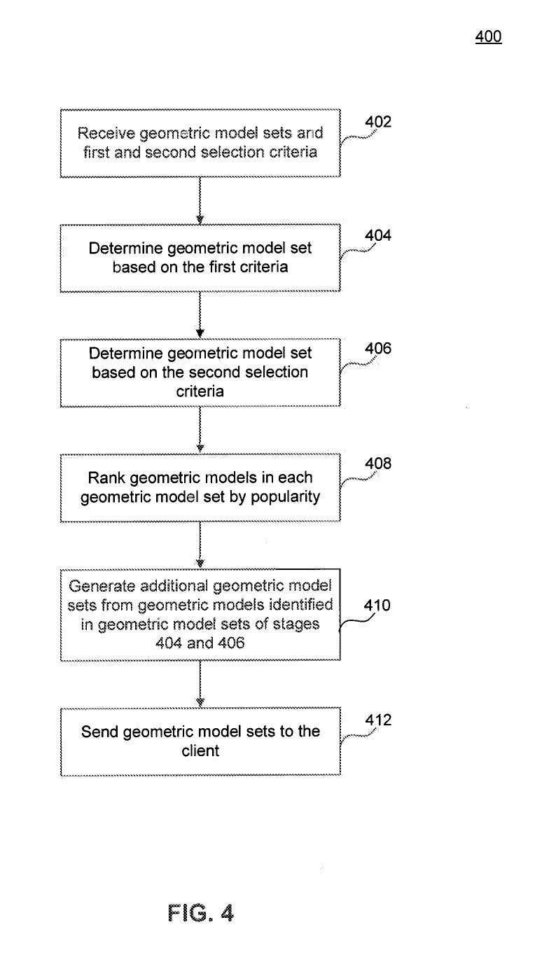

FIG. 4 is an example flowchart of a method 400 for determining geometric model sets for focal model 111a, according to an embodiment.

At stage 402, geometric model warehouse 110 receives focal model 111a and the first and second selection criteria.

At stage 404, model selector 114 determines a geometric model set based on the first selection criteria. For example, model selector 114 queries attributes of geometric models 111 in geometric model storage 112 that have the same attribute as focal model 111a and the first selection criteria. As described herein, the first selection criteria may be criteria set in selection menu 204x. Model selector 114 may generate a geometric model set, such as geometric model set 206.

At stage 406, model selector 114 determines a geometric model set based on the second selection criteria. For example, model selector 114 queries attributes of geometric models 111 in geometric model storage 112 that have the same attribute as focal model 111a and the second selection criteria. As described herein, the second selection criteria may be criteria set in selection menu 204y. Model selector 114 may generate a geometric model set, such as geometric model set 208.

At stage 408, generated geometric model sets are ranked according to their popularity. For example, model selector 114 retrieves a popularity score obtained by popularity module 116 and ranks geometric models 111 in geometric model sets generated in stages 404-408 according to their popularity score, as described herein.

At stage 410, additional geometric model sets may be generated. For example, model selector 114 may generate additional geometric model sets based on each geometric model 111 included in geometric model sets generated in stages 404 and 406 and the first and second criteria. In an embodiment, model selector 114 generates additional geometric model sets from geometric models 111 according to their popularity score.

At stage 412, geometric model sets are sent to client 104. For example, geometric model warehouse 110 sends geometric model sets of stages 408 and 410 to client 104.

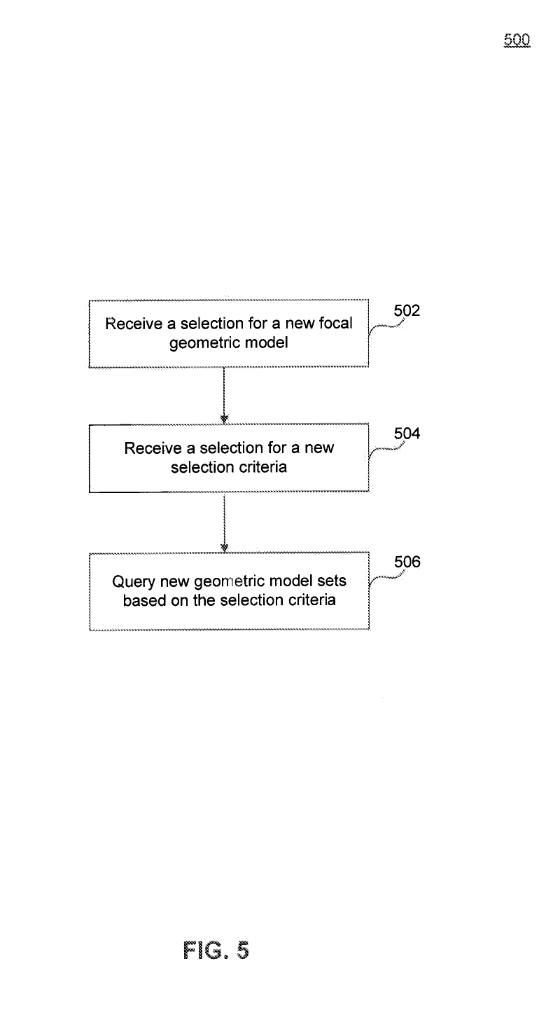

FIG. 5 is a flowchart of a method 500 for receiving a user selection, according to an embodiment.

At step 502, a selection of a new focal model 111a is received. For example, client 104 receives a selection from user 108 of geometric model 111 in geometric model sets 206 or 208 or other geometric model 111 that is displayed on the webpage. A selection may be a placement of one of the displayed geometric model 111 to the positive quadrant of the x-y axis.

At step 504, a selection of the criteria is received. For example, client 104 may receive a selection from a user for first or second criteria for a new focal model 111a. For example, user 108 may use a mouse or a keyboard to select new selection criteria from selection menu 204x or 204y.

At step 506, a query for the new geometric model sets and selected criteria is made for new focal model 111a, as described herein.

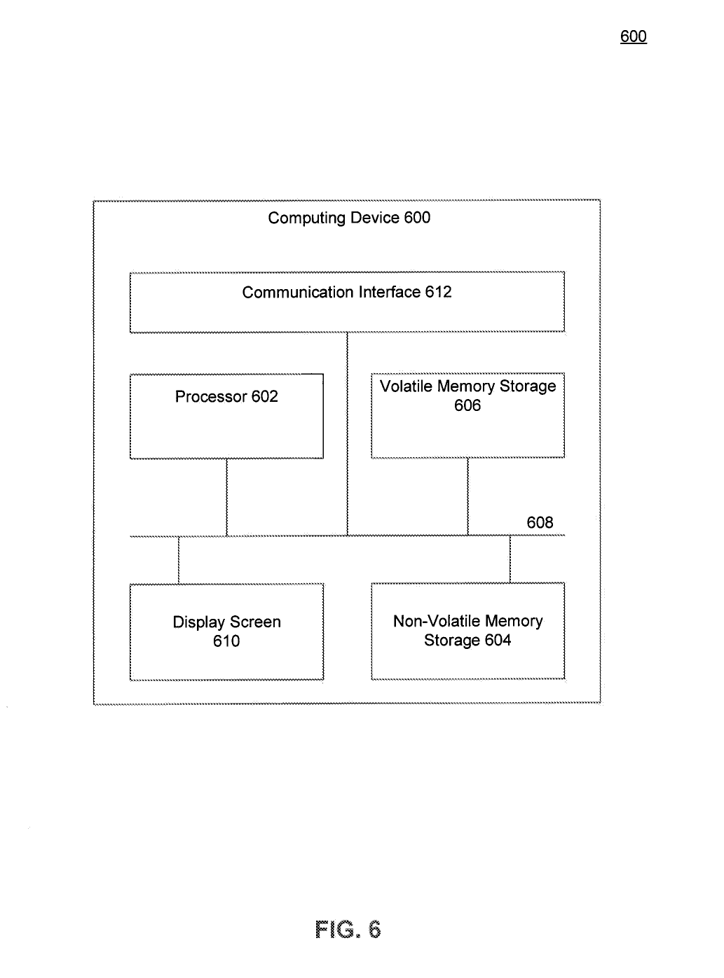

FIG. 6 is an example computer system 600 in which embodiments of the present invention, or portions thereof, may by implemented as computer-readable code. For example, the components or modules of system 100 such as model selector 114 or popularity module 116, may be implemented in one or more computer systems 600 using hardware, software, firmware, tangible computer readable media having instructions stored thereon, or a combination thereof and may be implemented in one or more computer systems or other processing systems. Modules and components in FIGS. 1-5 may be embodied in hardware, software, or any combination thereof.

Client 104 or web server 106 may include one or more computing devices. Client 104 or web server 106 may include one or more processors 602, one or more non-volatile storage mediums 604, one or more memory devices 606, a communication infrastructure 608, a display screen 610 and a communication interface 612. Processors 602 may include any conventional or special purpose processor, including, but not limited to, digital signal processor (DSP), field programmable gate array (FPGA), and application specific integrated circuit (ASIC). Non-volatile storage 604 may include one or more of a hard disk drive, flash memory, and like devices that may store computer program instructions and data on computer-readable media. One or more of non-volatile storage device 604 may be a removable storage device. Memory devices 606 may include one or more volatile memory devices such as but not limited to, random access memory. Communication infrastructure 608 may include one or more device interconnection buses such as Ethernet, Peripheral Component Interconnect (PCI), and the like.

Typically, computer instructions are executed using one or more processors 602 and can be stored in non-volatile storage medium 604 or memory devices 606.

Display screen 610 allows results of the computer operations to be displayed to a user or an application developer.

Communication interface 612 allows software and data to be transferred between computer system 600 and external devices. Communication interface 612 may include a modem, a network interface (such as an Ethernet card), a communications port, a PCMCIA slot and card, or the like. Software and data transferred via communication interface 612 may be in the form of signals, which may be electronic, electromagnetic, optical, or other signals capable of being received by communication interface 612. These signals may be provided to communication interface 612 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1-20. (canceled)

21. A computer-implemented method for browsing three-dimensional (3D) models;
receiving, h one or more computing devices, a first user input specifying a first criteria, wherein each of the one or more computing devices comprises one or more processors;
receiving, by the one or more computing devices, a second user input specifying a second criteria;
receiving, by the one or more computing devices, data describing a first set of 3D geometric models and a second set of 3D geometric models, the first set of 3D geometric models having been identified based at least in part on a focal model and the first criteria, the second set of 3D geometric models having been identified based at least in part on the focal model and the second criteria, wherein the focal model comprises a 3D geometric model being displayed to a user in a user interface;
providing, by the one or more computing devices, the first set of 3D geometric models for display along a first axis of the user interface; and
providing, by the one or more computing devices, the second set of 3D geometric models for display along a second axis of the user interface.

22. The method of claim 21, wherein:
the first axis comprises an x-axis; and
the second axis comprises a y-axis,

23. The method of claim 21, wherein:
the first criteria comprises geometric models of objects that are geographically near to the object modeled by the focal model; and
the second criteria comprises geometric models of objects that are similar in shape to the focal model.

24. The method of claim 21, further comprising providing, by the one or more computing devices, the focal model for display in an upper right quadrant of the user interface.

25. The method of claim 21, wherein:
each 3D geometric model included in the first set is ranked within the first set according to popularity;
each 3D geometric model included in the second set is ranked within the second set according to popularity;
the first set of 3D) geometric models are displayed along the first axis of the user interface according to their associated popularity rank; and
the second set of 3D geometric models are displayed along the second axis of the user interface according their associated popularity rank.

26. The method of claim 25, wherein the popularity rank of each 3D geometric model is determined based on a number of instances in which a plurality of users have selected such 3D geometric model.

27. The method of claim 21, wherein the first and second criteria comprise attributes associated with the focal model.

28. The method of claim 21, further comprising:
receiving, by the one or more computing devices, data describing one or more additional 3D geometric models, each of the one or more additional 3D geometric models having been identified based at least in part on one of the 3D geometric models included in the first set and the second criteria; and
providing, by the one or more computing devices, the one or more additional 3D geometric models for display in the direction of the second axis at the position on the first axis of the one of the 3D geometric models included in the first set upon which the one or more additional 3D geometric models were identified.

29. The method of claim 21, further comprising:
receiving, by the one or more computing devices, data describing one or more additional 3D geometric models, each of the one or more additional 3D geometric models having been identified based at least in part on one of the 3D geometric models included in the second set and the first criteria; and
providing, by the one or more computing devices, the one or more additional 3D geometric models for display in the direction of the first axis at the position on the second axis of the one of the 3D geometric models included in the second set upon which the one or more additional 3D geometric models were identified.

30. The method of claim 21, further comprising:
receiving, by the one or more computing devices, a user input, wherein the user input selecting one of the 3D geometric models included in either the first or second set as a new focal model; and
in response to the user input:
obtaining, by the one or more computing devices, data describing a third set of 3D geometric models and a fourth set of 3D geometric models, the third set of 3D geometric models having been identified based at least in part on the new focal model and the first criteria, the fourth set of 3D geometric models having been identified based at least in part on the new focal model and the second criteria;
providing, by the one or more computing devices, the third set of 3D geometric models for display along the first axis of the user interface, wherein the third set replaces the first set; and
providing, by the one or more computing devices, the fourth set of 3D geometric models for display along the second axis of the user interface, wherein the fourth set replaces the second set.

31. The method of claim 32, wherein the user input comprises the user dragging the selected one of the 3D geometric models included in either the first or second set and dropping the selected one of the 3D geometric models on top of the focal model.

32. A system for browsing models, the system comprising:
a web server comprising one or more computing devices, the web server being configured to:
identify a first set of 3D geometric models based at least in part on a focal model and a first criteria input by a user, wherein the focal model comprises a 3D geometric model that is displayed to the user in a user interface of a client device;
identify a second set of 3D geometric models based at least in part on the focal model and a second criteria input by the user; and
transmit the first and second set of 3D geometric models to the client device; and
the client device, wherein the client device is configured to:
display the first set of 3D geometric models along a first axis of the user interface; and
display the second set of 3D geometric models along a second axis of the user interface.

33. The system of claim 32, wherein:
the web server is further configured to rank each of the first set and the second set of 3D geometric models according to popularity; and
the client device is further configured to display the first set and the second set of 3D geometric models in order according to their respective popularity ranks,

34. The system of claim 32, wherein:
the web server is further configured to identify one or more additional 3D geometric models based at least in part on one of the 3D geometric models included in the first set and the second criteria; and
the client device is further configured to display the one or more additional 3D geometric models in the direction. of the second axis at the position on the first axis of the one of the 3D geometric models included in the first set upon which the one or more additional 3D geometric models were identified.

35. The system of claim 32, wherein:
the web server is further configured to identify one or more additional 3D geometric models based at least in part on one of the 3D geometric models included in the second set and the first criteria; and
the client device is further configured to display the one or more additional 3D geometric models in the direction of the first axis at the position on the second axis of the one of the 3D geometric models included in the second set upon. which the one or more additional 3D geometric models were identified.

36. The system of claim 32, wherein the client device is further configured to receive a user input scrolling either the first set of 3D geometric models along the first axis or the second set of 3D geometric models along the second axis.

37. The system of claim 32, wherein the web server searches a geometric model warehouse over a network to identify the first and second sets of 3D geometric models,

38. A computing device comprising one or more processors and one or more non-transitory computer-readable media storing instructions that, when executed by the one or more processors, cause the computing device to perform operations, the operations comprising:
receiving a first user input specifying a first criteria, wherein each of the one or more computing devices comprises one or more processors;
receiving a second user input specifying a second criteria;
obtaining data describing a first set of 3D geometric models and a second set of 3D geometric models, the first set of 3D geometric models having been identified based at least in part on a focal model and the first criteria, the second set of 31D geometric models having been identified based at least in part on the focal model and the second criteria, wherein the focal model comprises a 3D geometric model being displayed to a user;
displaying the first set of 3D geometric models along a first axis of the user interface;
displaying the second set of 3D geometric models along a second axis of the user interface;
receiving data describing one or more first additional 3D geometric models, each of the one or more first additional 3D geometric models having been identified based at least in part on one of the 3D geometric models included in the first set and the second criteria;
displaying the one or more first additional 3D geometric models in the direction of the second axis at the position on the first axis of the one of the 3D geometric models included in the first set upon which the one or more first additional 3D geometric models were identified;
receiving data describing one or more second additional 3D geometric models, each of the one or more second additional 3D geometric models having been identified based at least in part on one of the 3D geometric models included in the second set and the first criteria; and
displaying the one or more second additional 3D geometric models in the direction of the first axis at the position on the second axis of the one of the 3D geometric models included in the second set upon which the one or more second additional 3D geometric models were identified.

39. The computing device of claim 38, wherein the operations further comprise displaying the focal model in an upper right quadrant of the user interface.

40. The computing device of claim 38, wherein:
the first axis comprises an x-axis; and
the second axis comprises a y-axis,
